(19) United States
(12) Patent Application Publication
(10) Pub. No.: US 2018/0073719 A1
(43) Pub. Date: Mar. 15, 2018

(54) SLIM-LINED, SOLAR-POWERED LED LIGHTING SYSTEM AND OUTDOOR PATIO UMBRELLA HAVING THE SAME

(71) Applicant: Jason Bliss, Atlanta, GA (US)

(72) Inventor: Jason Bliss, Atlanta, GA (US)

(73) Assignee: ATLEISURE LLC, Atlanta, GA (US)

(21) Appl. No.: 15/262,239

(22) Filed: Sep. 12, 2016

(51) Int. Cl. F21V 33/00; F21V 23/04; F21V 23/00; F21S 4/28; F21S 9/03; F21V 3/00; A45B 23/00; A45B 25/14; A45B 25/02; A45B 17/00

(52) U.S. Cl. CPC F21V 33/0012; F21V 23/04; F21V 23/001; F21S 4/28; F21S 9/032; F21Y 2103/10; A45B 23/00; A45B 25/14; A45B 25/02; A45B 17/00; F21V 3/00

(57) ABSTRACT

An outdoor patio umbrella has a lower pole, an umbrella pole, a plurality of long ribs supported by the umbrella pole, and a canopy supported by the plurality of long ribs. At least one of the plurality of long ribs has, in cross section, a solid bottom wall, first and second upstanding side walls extending upward from the bottom wall, and an LED PCB extending between the first and second side walls. The PCB is attached to a conducting means, which attaches to a circuit board. The LEDs receive electricity from a rechargeable battery, which is charged by a solar panel. Other embodiments include LEDs for short ribs that connect to the long ribs and lower canopy slide. Additional embodiments include a center LED housed within a lower canopy slide.

### FIELD OF THE CURRENT DISCLOSURE

The current disclosure relates generally to outdoor patio umbrellas such as patio, offset, and market umbrellas; and more particularly to a slim-lined, solar-powered light emitting diode (“LED”) lighting systems for those outdoor patio umbrellas.

### BACKGROUND OF THE CURRENT DISCLOSURE

Large patio-style umbrellas are useful on patios, decks, pools, beaches, and in other outdoor settings for providing protection from the sun and allowing users a convenient way to enjoy shade while participating in outdoor activities. Often such activities continue into the night, and it is desirable to have convenient outdoor lighting.

Outdoor patio umbrellas have featured such lighting to illuminate the area under and around the outdoor patio umbrellas for some time. Lighting systems add to the ambiance of outdoor patio umbrellas and allows users to enjoy the umbrellas in time of low or no light. One method for providing such outdoor lighting is to equip the umbrella with lights powered by either household current or a battery. In the case of a battery-powered lighting system, a solar panel can charge the battery during periods of sunlight.

Concerning the actual lighting, to save space, offer light, and use common manufacturing processes, outdoor patio umbrellas have used metal ribs that house LED lighting systems. Current LED systems feature two electrical conductors that attach the LED to an electrical conducting means that would run the length of an outdoor patio umbrellas rib. Wires are current examples of conducting means.

CONNECTION. This LED lighting system presents many problems. For example, the electrical conductors attached to an LED would frequently become damaged or break off. Later, after replacing the LEDs several times in a particular socket, the socket would not hold the LEDs as firmly, or the LEDs would simply fall out. Worse, an LED electrical conductor could break inside the socket preventing an LED replacement.

When shipping outdoor patio umbrellas with current LED lighting systems, often several of the LEDs would not function. This is primarily due to disturbances to the outdoor patio umbrellas during shipping. LED electrical conductors would either fall out or break off. Consequently, outdoor patio umbrella manufacturers would have to include additional LEDs as well as warranty claims.

Additionally, since the LED lighting system is featured on outdoor patio umbrellas, another set of problems is encountered. For example, when exposed to rain and moisture, exposed leads from the LEDs to the socket produce corrosion, rust, and disconnection. As another example, typical LEDs require more electricity than do more recent lighting developments. Therefore, when sunlight is not available, the solar panels do not produce enough energy to sustain typical LEDs.

COST. Typically LEDs protruding out of a rib require a plastic bulb. The plastic bulb acts as a prism to radiate the LED's light. It also acts as protection from the aforementioned elements. However, the downside to plastic bulbs is that they do not have an attractive appearance, do not fit securely, and distract from the overall beauty that the LEDs provide in the first place.

As mentioned before, including additional plastic bulbs increases the cost of the umbrella, the weight of the umbrella when shipping, and other manufacturing considerations.

Manufacturing the ribs included a step to drill holes along the umbrella ribs so that the LEDs and plastic bulbs could protrude from the ribs. The drilled holes have a detrimental effect to the ribs' ability to withstand adverse outdoor conditions such as wind, rain, and snow. The weakened ribs are also subject to deformity or breaking.

SATISFACTION. For any of the forgoing problems, not having a functioning outdoor patio umbrella at the time of purchase leads to a decrease in customer satisfaction. Protruding LEDs, and their plastic bulbs exposed through the rib, are aesthetically unpleasing.

DESIGN CONSIDERATIONS. Lighting systems that use traditional LEDs have form factor considerations. A rib containing such an LED must be at least as tall as the socket holding the LED. And, the LED that protrudes out of the rib requires additional space. Finally, plastic bulbs over the LEDs require even more space.

Inside the ribs, LEDs of this type require complex wiring to connect every LED in all of the ribs to the battery and on to the solar-power source. The wiring also adds to production time and cost.

In sum, patio umbrellas can provide a convenient housing for the solar panel, battery, LEDs, and wiring needed for such lighting. It is desirable though, that the battery, LEDs, and conducting means be housed in such a way as to maximize the aesthetic appeal of the umbrella, minimize damage due to weathering, increase safety and convenience, and do so in a cost effective way.

For example, U.S. Pat. No. 9,408,444, issued Aug. 9, 2016, and titled “Lighting Umbrella” describes an improvement to umbrella lighting using surface mounted LEDs, teaches a completely different approach than the present disclosure. For example, the Lighting Umbrella's rib design requires two notches (ref. 101) inside a rib. This requires more internal area within a rib than the current disclosure. In the current disclosure, notches are optional, and even if used, require less area than the prior art. Moreover, manufacturing two notches in the Lighting Umbrella's rib is more complicated and expensive to manufacture than the rib of the current disclosure.

Additionally, each LED-bearing rib contains a limited number of LEDs (ref. 104) where the LEDs emit light along the rib similar to a fluorescent tube light that flows light longitudinally. The LED is mounted 90 degrees to the diffusing bar (ref. 106), which is not directed toward the ground. In the current disclosure, the LEDs face downward and provide better lighting.

Further, as seen by FIG. 11, the Lighting Umbrella's design does not simplify and eliminate extraneous wiring. Rather, each LED requires its own wiring pair. The current disclosure allows a plurality of LEDs connected by a single wiring pair.

Finally, the Lighting Umbrella still incorporates extraneous components to its LEDs (ref. 103), such as a fixed base (ref. 7) and a through hole (ref. 702) that must be mounted on the printed circuit board (“PBC”) light bar (105). The current disclosure does not have a removable PCB lamp panel (ref. 104) that could break off.

Embodiments of the current disclosure address the abovementioned and other unfulfilled shortcomings.

### SUMMARY OF THE CURRENT DISCLOSURE

Embodiments of the current disclosure provide an attractive, safe, and convenient way of housing lights or other electrical appliances and wiring within a patio umbrella where ribs have a flat bottom wall, eliminating the need to drill a plurality of LED holes in the ribs, reducing wiring, and providing a compact, slim-lined design to the ribs. When compared to prior umbrellas with LEDs, the current disclosure provides for reduced and quicker manufacturing, easier setup, reduced LED failure, and an overall higher-strength umbrella.

Stated somewhat more specifically, one embodiment of the current disclosure comprises an outdoor patio umbrella featuring a solar-powered LED lighting system that eliminates the need for holes to house LEDs, for spare LEDs, for plastic bulbs, for extraneous wiring and reduces the area required to house all of the foregoing. The main aspects of the current disclosure, that differentiate it from the prior art, are use of surface mounted LEDs on a conducting means and an electronic circuit board that controls the LEDs and protects the rechargeable battery.

The umbrella features an umbrella pole attached to a lower pole, a plurality of long ribs connected at one end to a radial umbrella plate that traverses up and down the umbrella pole, an equal number of short ribs as long ribs where one end of short ribs is connected at one end to an intermediate position between the two ends of the long rib, the other end of the short ribs radially connects to a lower canopy slide, and the long ribs support a canopy. The umbrella opens and closes by turning a crank with a rope attached to move the lower canopy slide.

The solar-powered LED lighting system features a rechargeable battery to provide electricity to solar powered LEDs, a solar panel that converts optical energy to electrical energy that charges the rechargeable battery, a plurality of surface mounted LEDs that provide lighting, and a circuit board that controls the surface mounted LEDs and protects the rechargeable battery. A transparent cover attached to an LED-containing rib, slides into that rib opposite the LED and conducting means.

The slim-lined solar-powered LED lighting system as described eliminates the need to drill holes in any of the long or short ribs to house LEDs. Further, the solar powered LED lighting system reduces the area within any long or short rib that contains LEDs within. Further yet, the surface mounted LEDs, connected via conducting means, and the transparent cover, simplifies and reduces the cost of manufacturing.

### BRIEF DESCRIPTION OF THE DRAWINGS

The accompanying drawings illustrate one or more embodiments of the current disclosure and together with the written description, serve to explain the principles of the current disclosure. Wherever possible, the same reference numbers are used throughout the drawings to refer to the same or like elements of an embodiment, and wherein:

FIG. 1 is an end view of a slim-lined, solar-powered LED lighting system inside a rib;

FIG. 2 is a partial perspective view, shown partially in cross section, showing a slim-lined, solar-powered LED lighting system without a transparent cover;

FIG. 3 is a perspective view showing a slim-lined, solar-powered LED lighting system with a transparent cover;

FIG. 4 is an exterior view of a slim-lined, solar-powered LED lighting system showing illumination through a transparent cover;

FIG. 5 shows an exemplary circuit diagram of the solar-powered, battery LED lighting system circuit board installed on a large umbrella according to one embodiment of the current disclosure;

FIG. 6 is a perspective view of a large umbrella having the solar-powered LED lighting system, and FIG. 7 is a partial side elevational view of a large umbrella having the solar-powered LED lighting system with its canopy removed according to certain embodiments of the current disclosure;

FIG. 8 is a partial exploded view of a large umbrella having the solar-powered LED lighting system with its canopy removed according to certain embodiments of the current disclosure;

FIG. 9 is a partial exploded view of a slim-lined LED lighting system and ribs according to certain embodiments of the current disclosure;

FIG. 10A is an end view of a slim-lined, solar-powered LED lighting system. FIG. 10B is a partial side elevational view showing a slim-lined, solar-powered LED lighting system with a light cover;

FIG. 11 is an exploded diagrammatical view of a slim-lined, solar-powered LED lighting system attached to electrical circuits and a solar power source according to certain embodiments of the current disclosure;

FIGS. 12A-C are cross sectional views of different rib embodiments according to certain embodiments of the current disclosure; and

FIG. 13 is a perspective view of a large offset umbrella having a solar-powered LED lighting system according to one embodiment of the current disclosure.

### DETAILED DESCRIPTION OF THE CURRENT DISCLOSURE

The current disclosure will now be described more fully hereinafter with reference to the accompanying drawings, in which exemplary embodiments of the current disclosure are shown. This current disclosure may, however, be embodied in many different forms and should not be construed as limited to the embodiments set forth herein. Rather, these embodiments are provided so that this disclosure will be thorough and complete, and will fully convey the scope of the current disclosure to those skilled in the art. Like reference numerals refer to like elements throughout.

In an exemplary embodiment, each of the long and short plurality of ribs, in cross section, contains a bottom wall, first and second upstanding side walls extending upward from the bottom wall, a top wall connected to each side wall, a transparent cover secured by the top walls and a set of upper grooves, a conducting means secured by the bottom wall and set of lower grooves, and at least one LED connected to the conducting means.

In other exemplary embodiments, not every rib will include an LED and transparent cover.

Embodiments of the current disclosure feature surface mounted LEDs. Surface mounted LEDs are low power, straightforward, thin, lightweight, highly resistant to shock and vibrations, and easy to work with. Surface mounted LEDs also feature an integrated heat sink to dissipate any heat. Surface mounted LEDs are preferred to traditional LEDs because they are simpler and less expensive to manufacture.

When securing the LEDs and conducting means to the plurality of ribs, they are slid into the ribs. The conducting means is typically a PCB. Similarly, when securing a transparent cover to the plurality of ribs, the transparent covers are slid into the ribs.

In embodiments that feature LEDs inside short ribs, each short rib LED is electrically connected to a center LED circuit board, which is then electrically connected via a connecting wire to a circuit board. In embodiments that feature LEDs inside long ribs, each long rib LED is connected to the circuit board. In either case, the circuit board is connected to at least one umbrella light control switch and to electrical power.

A single PCB, that contains a plurality of LEDs, connects to electrical power with a single set of wires.

In one aspect of the current disclosure, the electrical power is a battery housed within a solar-power source. A solar panel converts optical energy to electrical energy and charges the rechargeable battery. In another aspect, the electrical power is alternating current (“AC”) from an electrical outlet, which also charges the battery.

When an umbrella light control switch is closed, electricity flows to the LEDs, and they shine through the rib and transparent cover. In an alternative embodiment, a switch allows auto detection for an illumination sensor to automatically switch the LED lighting system on during periods of low or no light.

In certain embodiments, the umbrella comprises: a canopy, a lower pole and umbrella pole, a lower canopy slide to move up and down along the poles to open and close the umbrella, a crank with a cord or other means attached to the lower canopy slide to move the lower canopy slide up and down when a user turns the crank, a certain number of long ribs to support the canopy, and an equal number of short ribs. Each of the short ribs has a first end and a second end. A first end of the short rib is connected to the lower canopy slide and a second end is connected to one of the long ribs.

In one embodiment, the slim-lined, solar-powered LED lighting system is installed on a market umbrella. In another embodiment, the slim-lined, solar-powered LED lighting system is installed on an offset umbrella.

In one embodiment, the LEDs are installed on the long ribs of the umbrella. In another embodiment, the LEDs are installed on both the long and short ribs of the umbrella.

In certain embodiments, the LEDs include a first set of LEDs, and a second set of LEDs. The first set of LEDs is installed on the long ribs of the umbrella, and the second set of LEDs is installed on a lower canopy slide. In yet another embodiment, the LEDs are installed on long ribs, short ribs, and the lower canopy slide.

Any combination of the three LED placements may be used in another embodiment of the current disclosure.

A rechargeable battery is typically lithium ion. The circuit board contains a pair of metal oxide semiconductor field-effect transistors (“MOSFET”) connected to an integrated circuit (“IC”), which protects the rechargeable lithium ion battery from damage or degrading due to overcharge, over-discharge, or overcurrent. Positive and negative voltages from the battery provide electricity to the LEDs turning them off and on, optionally with switches.

A common IC used for battery protection is a DW01-U1; however, DW01-P and similar ICs may be used.

In a preferred embodiment, an 8205 dual MOSFET is used.

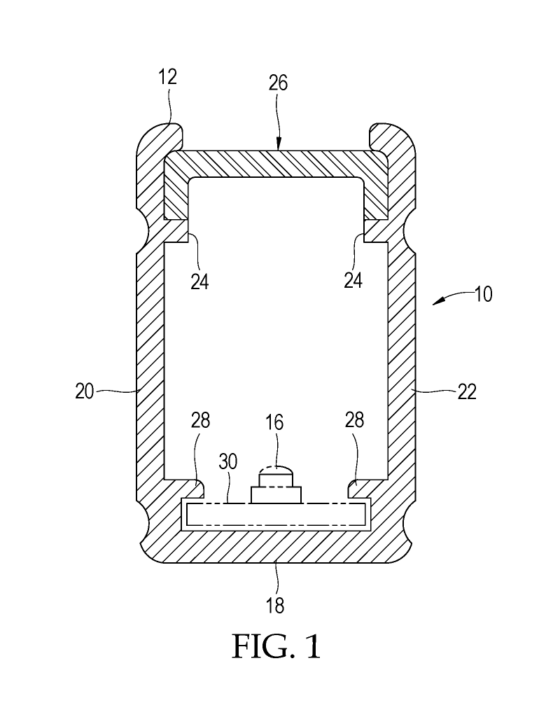

The description will be made as to the embodiments of the current disclosure in conjunction with the accompanying drawings in FIGS. 1-13. In accordance with the purposes of this current disclosure, as embodied and broadly described herein, this current disclosure, in one aspect, relates to an umbrella with a solar-powered LED lighting system. LEDs 16 include long rib LEDs 32, short rib LEDs 39, and center LEDs 5, and differ only as to location of the LEDs.

FIGS. 1-3 depict a rib 10 to support a canopy 1. The rib 10 includes a top wall 12 that has an opening extending down the length of the rib to an LED 16. The rib 10 includes a bottom wall 18 and two sidewalls 20, 22 extending between the top wall 12 and bottom wall 18. A set of upper notches 24 secure a transparent cover 26. The bottom wall 18 and set of lower notches 28 secure the LEDs 16 and conducting means 30. Examples of conducting means include a printed circuit board (shown) or a flexible ribbon.

A set of indentations 10 on its sidewalls 20, 22 are optional and serve as decoration.

The set of upper notches 24 and top wall 12 is unnecessary if the transparent cover 26 is fixed to the sidewalls 20, 22 with an attaching means. Such means include glue, epoxy, solder, and the like. Similarly, the set of lower notches 28 is unnecessary if the conducting means 30 is fixed to the bottom wall 18 with an attaching means.

While the height of the depicted LED 16 is exaggerated, the LEDs 16 are relatively thin. The LEDs 16 are preferably surface mounted devices, but are not limited to them.

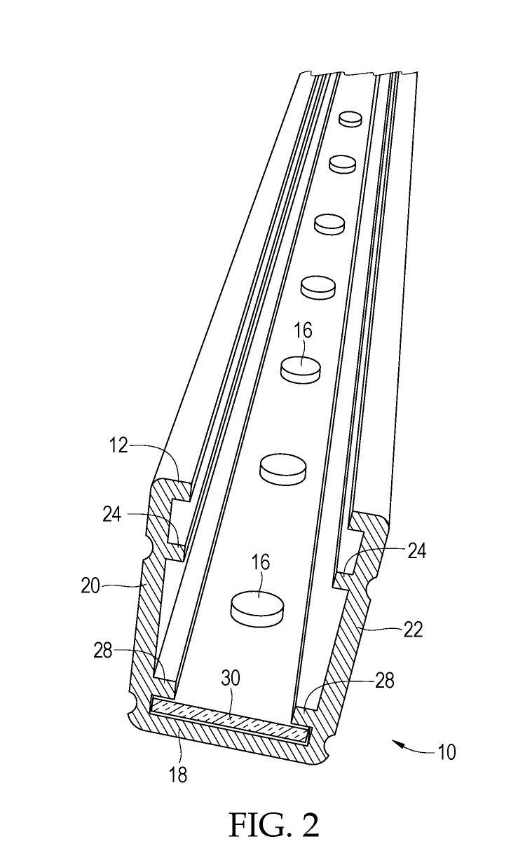

FIG. 2 is a perspective view of the rib 10 without the transparent cover 26.

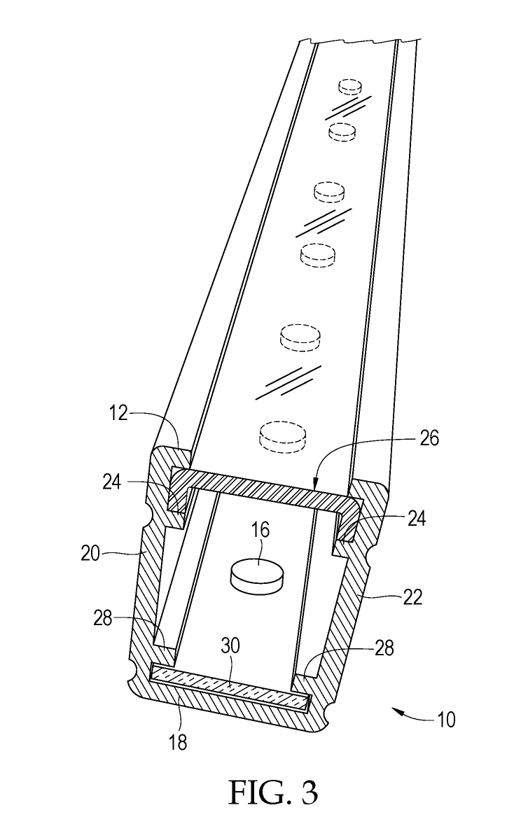

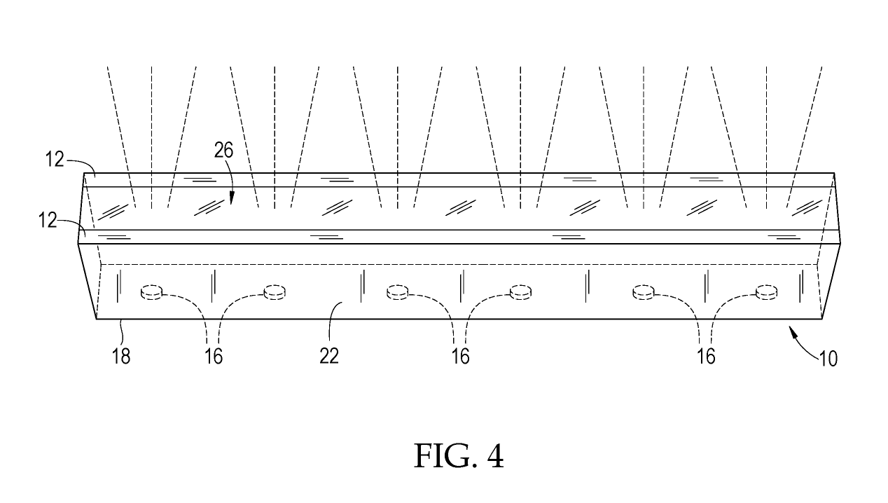

FIG. 3 is a perspective view of the rib 10 with the transparent cover 26.

FIG. 4 is an exterior, open view of the rib 10 where a sidewall 22 is cut away and where the LEDs 16 illuminate through the transparent cover 26 shown in broken lines.

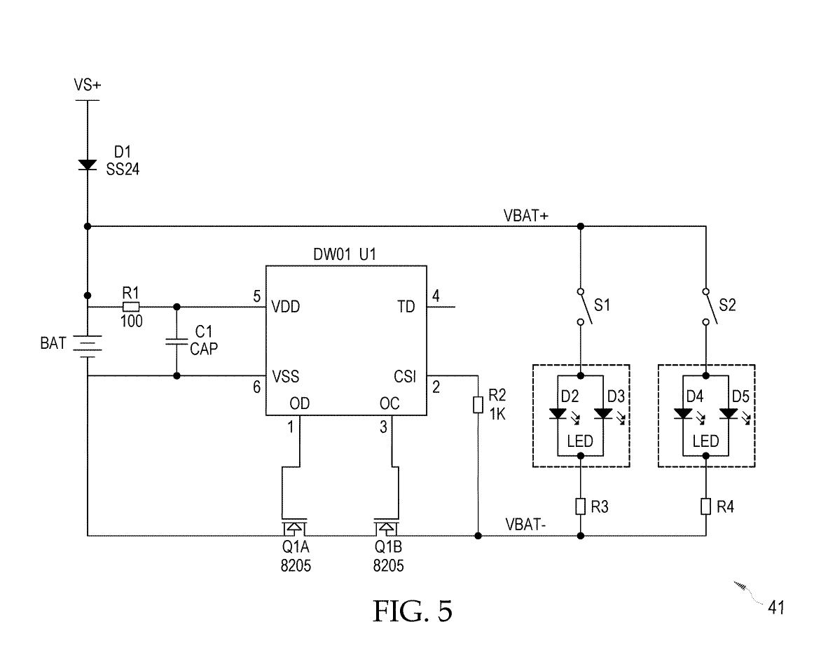

FIG. 5 is an electrical circuit diagram of circuit board 41. A solar panel 4 and battery BAT provide direct current VS+to the circuit. The direct current VS+ flows to a diode D1 connecting the positive output terminal of the solar panel 4 to the positive terminal of a rechargeable battery BAT to control the direction of electricity generated. The diode D1 only allows the current to flow from the solar panel 4 to the rechargeable battery BAT, not the other way around.

The positive battery terminal provides positive voltage VBAT+ to switches S1 & S2 that turn the LEDs on and off. The positive battery terminal provides positive voltage VBAT+ to a resistor R1 and on to a voltage drain VDD of the battery protection IC DW01-U1.

A negative battery terminal provides negative voltage VBAT− to MOSFET Q1A and on to the IC's DW01-U1 MOSFET gate connection pin for discharge control OD and to MOSFET Q1B and on to the IC's DW01-U1 MOSFET gate connection pin for charge control OC. Additionally, the negative battery terminal provides negative voltage VBAT− to a resistor R2 and on to the IC's DW01-U1 input pin for current sense input, charger detect CSI. Finally, the negative battery terminal provides negative voltage VBAT− to the LEDs through resistors R3 and R4.

The circuit board does not use the IC's DW01-U1 test pin for reduce delay time TD.

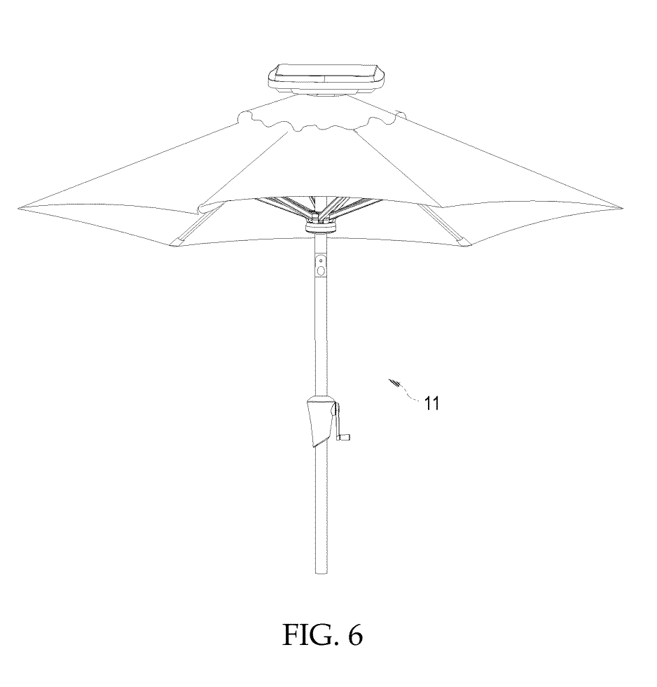

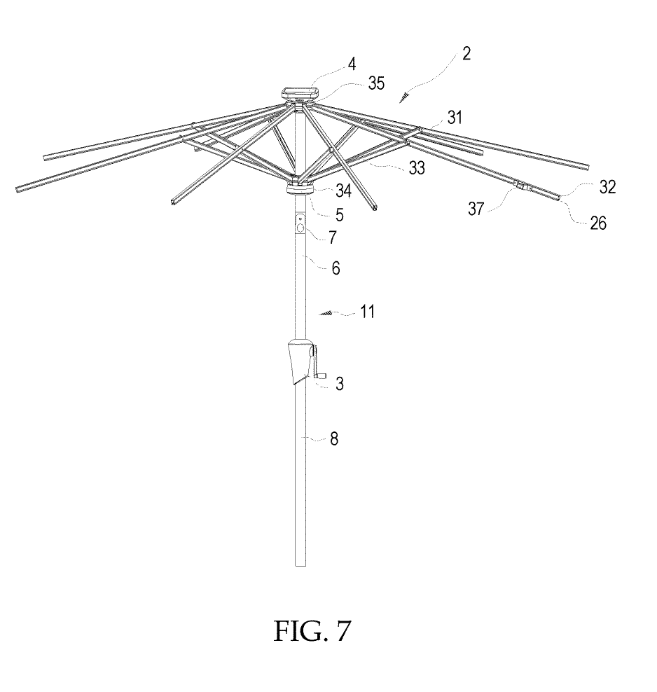

FIG. 6 is a perspective view of an outdoor market patio umbrella 11 featuring slim-lined, solar-powered LED lights.

FIG. 7 is a perspective view of an outdoor market patio umbrella 11 having slim-lined, solar-powered LEDs 2 with its canopyl removed. Slim-lined, solar-powered, LED lights 2 include long rib LEDs 32, short rib LEDs 39, and center LEDs 5, depending on their location. Combinations of the three vary according to different embodiments of the current disclosure.

The outdoor market patio umbrella 11 slim-lined, solar-powered, LED lights 2 connected to a solar panel 4. Long ribs 31 connect to a radial umbrella plate 35, which attaches to an umbrella pole 6, which attaches to a lower pole 8. Inside the umbrella pole 6 and lower pole 8 is a rope 3 to open and close the long and short ribs 31, 33. Tilt is also available using the outdoor market patio umbrella's 11 tilt feature.

A lower canopy slide 34, which contains the center LED 5, moves up and down along the poles 6, 8 to open and close the outdoor market patio umbrella 11. The outdoor market patio umbrella 11 has the same number of long ribs 31 and short ribs 33. Each of the short ribs 33 has a first end and a second end. The first end of the short rib 33 is connected to the lower canopy slide 34, and the second end is connected to one of the long ribs 31.

In one embodiment of the current disclosure, at least one of the ribs 31, 33 contain at least one umbrella light control switch 37. Additionally, at least one long rib 31 contains a long rib LED 32 and transparent cover 26.

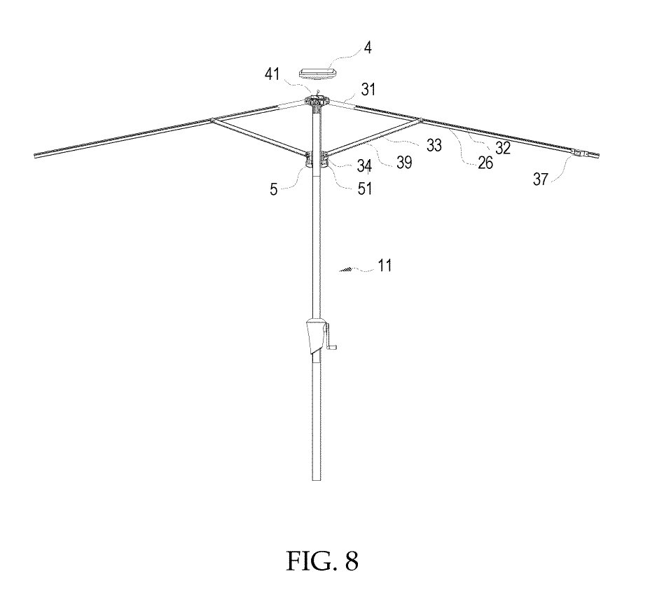

FIG. 8 is a perspective view of the outdoor market patio umbrella 11 seen in FIG. 7. In addition to the components in FIG. 7, FIG. 8 highlights the electrical components in the short and long ribs 33, 31. Electrical power enters the solar panel 4 and flows to a battery, which is connected to a circuit board 41. At least one of the ribs 31, 33 contain at least one umbrella light control switch 37. Additionally, at least one long rib 31 contains a long rib LED 32 and transparent cover 26. Similarly, in one embodiment, at least one short rib 33 contains at least one short rib LED 39. Again, in one embodiment, the lower canopy slide 34 contains a center LED 5 and center LED circuit board 51.

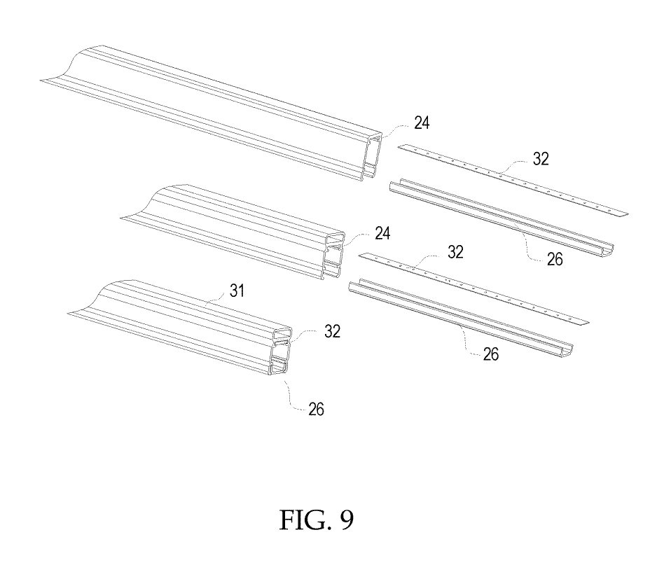

FIG. 9 is a perspective view of a long rib 31 that houses both a long rib LED 32 and a transparent cover 26. In one embodiment, the long rib LEDs 32 are held in place by a set of upper grooves 24.

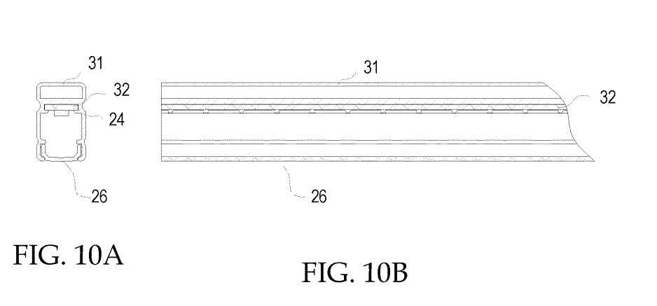

FIG. 10A is an end view of a long rib 31 with long rib LEDs 32 and a transparent cover 26. FIG. 10B is a perspective view showing the same components.

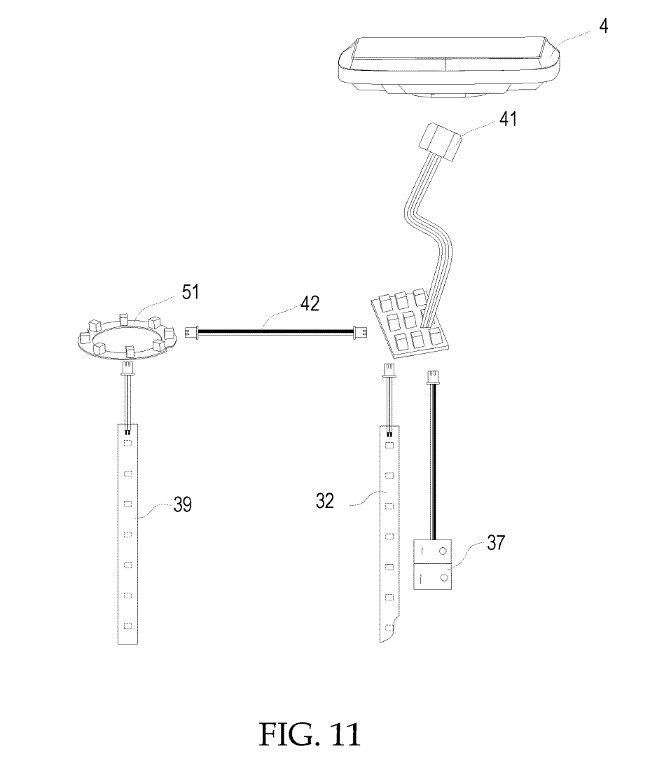

FIG. 11 is a perspective view of short rib LEDs 39 connected to a center LED circuit board 51, which connects to a connecting wire 42, which connects to a circuit board, which connects to a solar panel 4 according to one embodiment of the current disclosure. Additionally, a long rib LED and at least one umbrella light control switch 37 connects to a circuit board according to one embodiment of the current disclosure.

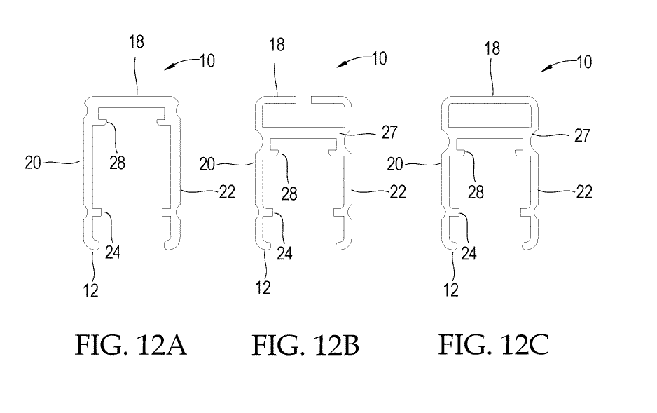

FIGS. 12A-C are end views of different rib embodiments according to certain embodiments of the current disclosure. Each view depicts a rib 10, inverted from FIGS. 1 and 2, to support a canopy 1. The rib 10 includes a top wall 12 that has an opening extending down the length of the rib to an LED 16. The rib 10 includes a bottom wall 18 and two sidewalls 20, 22 extending between the top wall 12 and bottom wall 18. A set of upper notches 24 secure a transparent cover 26. The bottom wall 18 and set of lower notches 28 secure the LEDs 16 and conducting means 30.

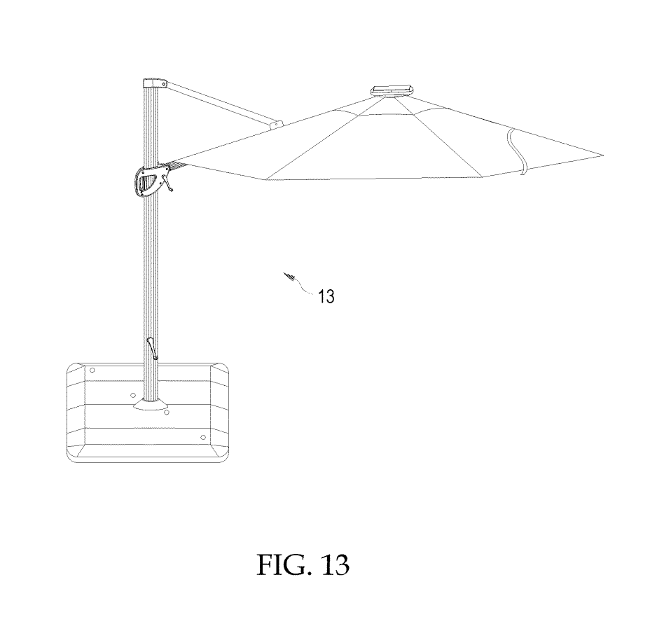

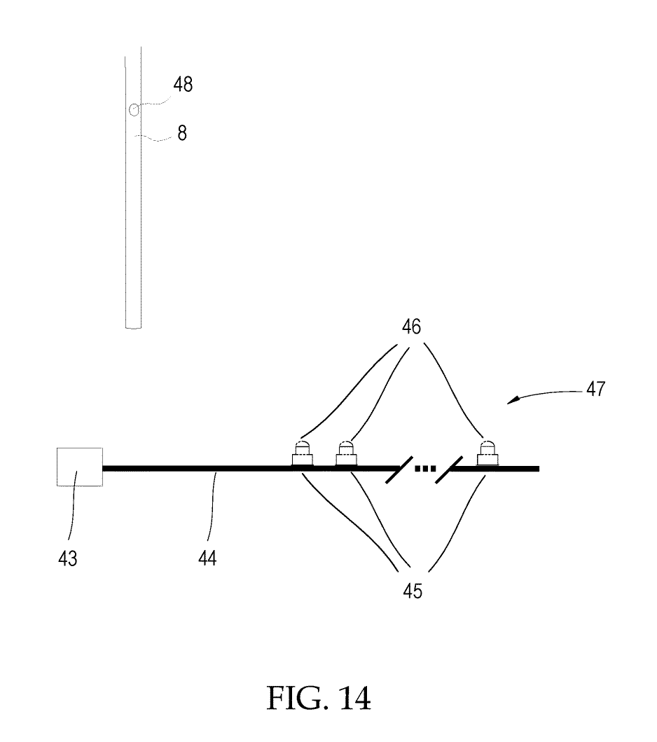

FIG. 13 is a perspective view of an outdoor offset patio umbrella 13 featuring slim-lined, solar-powered, LED lights.

The current disclosure provides for a rib with a flat bottom wall, ribs that accept a U-shaped cover for dispersion of light, and PCBs and LEDs. The current disclosure features a flat bottom wall without holes, rather with solid, longitudinal walls.

1. A slim-lined, solar-powered LED lighting system for an umbrella, wherein the solar-powered LED lighting system comprises:
a plurality of LEDs for lighting wherein said plurality of LEDs are surface-mounted LEDs;
a rechargeable battery configured to provide electricity to of LEDs;
a solar panel configured to convert optical energy to electrical energy for charging the rechargeable battery;
a circuit board that protects the rechargeable battery;
wherein the circuit board comprises:
at least one MOSFET; and
an integrated circuit; and
a cover; and
wherein the umbrella comprises:
a canopy;
a lower pole;
an umbrella pole;
a lower canopy slide to move up and down along the poles to open and close the umbrella;
a crank with a rope attached to move the lower canopy slide up and down when the crank is turned by a user;
a plurality of long ribs to support the canopy; and
a plurality of short ribs, wherein each of the plurality of short ribs has a first end connected to the lower canopy slide and a second end connected to one of the plurality of long ribs;
wherein said plurality of LEDs are installed on said lower canopy slide, installed on at least one of said plurality of long ribs, and/or installed on at least one of said plurality of short ribs.

2. The solar-powered LED lighting system of claim 1, wherein at least one long rib contains at least one of said plurality of LEDs.

3. The solar-powered LED lighting system of claim 1, wherein at least one short rib contains at least one of said plurality of LEDs.

4. The solar-powered LED lighting system of claim 1, wherein said plurality of LEDs comprises:
a first set of LEDs installed on the plurality of long ribs and/or the plurality of short ribs of the umbrella; and
a second set of LEDs installed on a lower canopy slide.

5. The slim-lined, solar-powered LED lighting system of claim 2, wherein the LEDs are controlled by at least one switch.

6. The slim-lined, solar-powered LED lighting system of claim 3, wherein the LEDs are controlled by at least one switch.

7. The slim-lined, solar-powered LED lighting system of claim 4, wherein the LEDs are controlled by at least one switch.

8. The slim-lined, solar-powered LED lighting system of claim 1, further comprising a power output connector positioned on the lower pole of the umbrella and configured to provide electricity to a separate lighting device.

9. The slim-lined, solar-powered LED lighting system of claim 8, wherein the separate lighting device comprises a LED light strip, wherein the LED light strip comprises:
a power connector to connect to the power output connector of the solar-powered LED lighting system;
a set of LED lights,
a plurality of LED light sockets configured to install set of LED lights; and
a wire to connect the electricity from the power connector to the plurality of LED light sockets and the set of LED lights.

10. A market umbrella comprising the solar-powered LED lighting system of claim 2.

11. A market umbrella comprising the solar-powered LED lighting system of claim 3.

12. A market umbrella comprising the solar-powered LED lighting system of claim 4.

13. An offset umbrella comprising the solar-powered LED lighting system of claim 2.

14. An offset umbrella comprising the solar-powered LED lighting system of claim 3.

15. An offset umbrella comprising the solar-powered LED lighting system of claim 4.

16. An umbrella assembly comprising:
a rib-insertable LED assembly, wherein said rib-insertable LED assembly includes one or more LEDs mounted on a conducting means and is adapted for sliding insertion into a rib;
a lower canopy slide capable of sliding on an umbrella pole;
a plurality of long ribs capable of supporting a canopy;
a plurality of short ribs, wherein each of the plurality of short ribs has a first end connected to the lower canopy slide and a second end connected to one of the plurality of long ribs; and
at least one of said plurality of long ribs or at least one of said plurality of short ribs comprises:
a bottom wall;
a left-side wall and a right-side wall extending up from the bottom wall;
a top wall connected to the left-side wall and the right-side wall;
a left lower-notch protuberance extending rightward from said left-side wall;
a right lower-notch protuberance extending leftward from said right-side wall;
the left lower-notch protuberance, the right lower-notch protuberance, and the bottom wall together forming and bounding an LED assembly-accepting zone;
said rib-insertable LED assembly residing in said LED assembly-accepting zone;
optionally, a left upper-notch protuberance extending rightward from said left-side wall;
optionally, a right upper-notch protuberance extending leftward from said right-side wall; and
no additional notch protuberances extending inwardly from said right- or left-side walls.

17. The umbrella assembly of claim 16, wherein said conducting means is a PCB.

18. The umbrella assembly of claim 17, wherein at least one of said one or more LEDs is a surface-mounted LED.

19. The umbrella assembly of claim 18, wherein said optional left upper-notch protuberance and said optional right upper-notch protuberance are present, and a cover allowing transmission of light is installed between said upper-notch protuberances and said top wall.
